(19) United States
(12) Patent Application Publication
(10) Pub. No.: US 2023/0301283 A1
(43) Pub. Date: Sep. 28, 2023

(54) Fishers Lure

(71) Applicant: Joseph Renosky, Indiana, PA (US)

(72) Inventor: Joseph Renosky, Indiana, PA (US)

(21) Appl. No.: 18/125,232

(22) Filed: Mar. 23, 2023

Related U.S. Application Data
(60) Provisional application No. 63/322,693, filed on Mar. 23, 2022.

(51) Int. Cl. A01K 85/18; A01K 85/00

(52) U.S. Cl. CPC A01K 85/18; A01K 85/1837

(57) ABSTRACT

A fishers lure that includes a lure body, a top blade attached to the lure body in a configuration whereby an oscillating motion is created as movement of the fishers lure through the water displaces the blade relative to the lure body. The lure body has at least two fishhooks that is a treble hook with a swivel member extending from the bottom of the treble hook, the swivel configured for releasably attaching a selected blade. The lure body defines a first loop that is disposed on a front portion of the lure body for attaching a top blade, a second loop disposed on a lower portion of the lure body for attaching the fishhook, and a third loop that is disposed on a rear portion of the lure body for attaching the fishhook. The lure body may include an additional loop disposed on the lower portion of the lure body for attaching the fishhook. Each of the fishhooks include the swivel member configured for releasably attaching the selected blade.

### CROSS REFERENCES TO RELATED APPLICATIONS

U.S. Provisional Application for Patent No. 63/322,893, filed Mar. 23, 2022, with title “Fishers Lure” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

### 1. Field of the Invention

The present disclosure relates generally to fishing and fishing lures.

### 2. Background Information

There have been many changes and improvements and improvements in fishing lures over the years. Many lures relate to specific applications and to catching specific fish in specific conditions. Generally, lures attempt to attract fish by movement, sound and action that imitate nature or in some way excites the fish's interest. There is always a need in this industry for a fishing lure with a unique and/or improved movement and action. A lure which possesses desirable characteristics that will attract fish.

The present invention addresses the shortcomings of previous fishing lures. As will be seen, there has not been available a fishers lure with the advantages and features of the present invention.

### SUMMARY OF THE INVENTION

A fishers lure that includes a lure body, and a top blade attached to the lure body in a configuration whereby an oscillating motion is created as movement of the fishers lure through the water displaces the blade relative to the lure body. The lure body comprises at least one eye and multiple fishhooks, each fishhook preferably being a treble fishhook consisting of three (3) hooks with a welded crane swivel extending from the bottom of the treble hook. The swivel configured for releasably attaching a blade.

The lure body further defines a first loop that is disposed on a front portion of the lure body for attaching a top blade, the top blade is attached in a configuration causing an oscillating motion. The top blade is a generally flat blade having a bend near an end of the blade to decrease the effective surface area of the blade, in order to decrease the amount of drag the blade presents as the fishers lure is pulled through the water.

The lure body preferably includes a second loop that is disposed on a lower portion of the lure body for attaching the fishhook, and a third loop that is disposed on a rear portion of the lure body for attaching the fishhook. The lure body may include an additional loop disposed on the lower portion of the lure body for attaching the fishhook. Each of the fishhooks attached as described, include the welded crane swivel extending from the bottom of the treble hook, configured for releasably attaching the selected blade.

The present invention is configured to include multiple treble fishhooks, each fishhook configured to add selected different shape blades for the desired action. A fisherman may therefore releasably connect a first design blade to the fishhook attached to the second loop disposed on the lower portion of the lure body, a different shaped blade to the fishhook attached to the third loop disposed on the rear portion of the lure body and, a different shaped blade may be used with the fishhook attached to the additional loop disposed on the lower portion of the lure body. Each of the different shaped blades for creating a desired action and reaction movement of the fishers lure through the water. As such, the fisherman can put different size and shape blades on the defined lower and rear portions of the lure body to give the lure different actions in use.

### BRIEF DESCRIPTION OF THE DRAWINGS

FIG. 1 is a perspective view of the present invention, a fishers lure.

FIG. 2 is a side sectional view of the present invention

FIG. 3 is a side view of the present invention's top blade and snap fastener.

FIG. 4 shows an alternate embodiment of the fishers lure that further illustrates a two-hook design rather than a three-hook design.

### DESCRIPTION OF THE PREFERRED EMBODIMENT

The present invention is directed to a fishers lure used for attracting fish. More particularly, the present invention discloses a fishers lure that can enhance and improve the chances of catching fish. A versatile fishers lure (you can troll it, cast it, vertical jig it) that can be used at any depth to get at any suspended fish. In the broadest context, the fishers lure of the present invention consists of components configured and correlated with respect to each other so as to attain the desired objective.

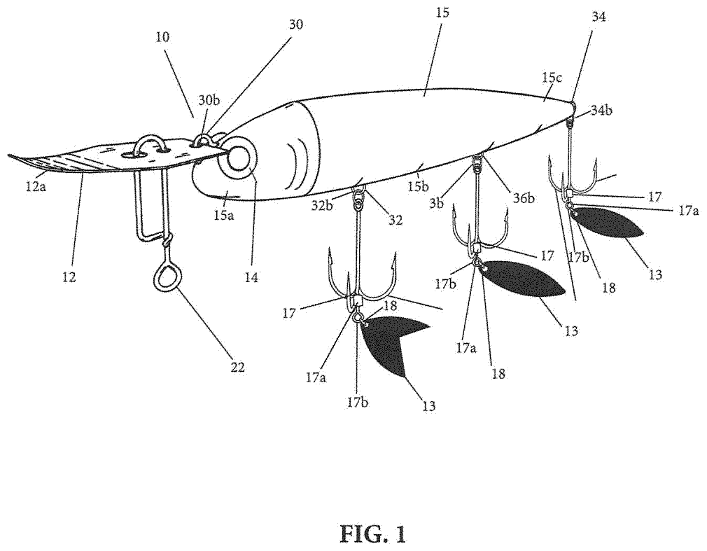

Referring to the drawings, the present invention is a fishers lure, designated as numeral 10. Referring to FIG. 1, the fishers lure 10 includes a lure body 15, and a top blade 12 being attached to the lure body 15 in a configuration whereby an oscillating motion is created as movement of the fishers lure 10 through the water displaces the blade 12 relative to the lure body 15. A fishing line (not shown) is connected to the blade 12 by a snap fastener 22.

The lure body 15 comprises at least one eye 14 and multiple fishhooks 17. As illustrated, the fishhook 17 is preferably a treble hook consisting of three (3) hooks with a swivel member preferably a welded crane swivel 17a extending from the bottom of the treble hook. As further illustrated, the swivel member 17a configured for releasably attaching a blade 13. In particular, the swivel member 17a defines an eyelet 17b for releasably receiving a split or crimped ring 18 and the blade 13. The swivel member 17a allowing the blade 13 a swivel action during application.

The lure body 15 defines a first loop 30 that is disposed on a front portion 15a of the lure body 15 for attaching the top blade 12. As disclosed, the lure body 15 includes a second loop 32 that is disposed on a lower portion 15b of the lure body 15 for attaching the fishhook 17, and a third loop 34 that is disposed on a rear portion 15c of the lure body 15 that may be used for attaching the fishhook 17. The fishhook 17 as described, is preferably attached directly to the second and third loops.

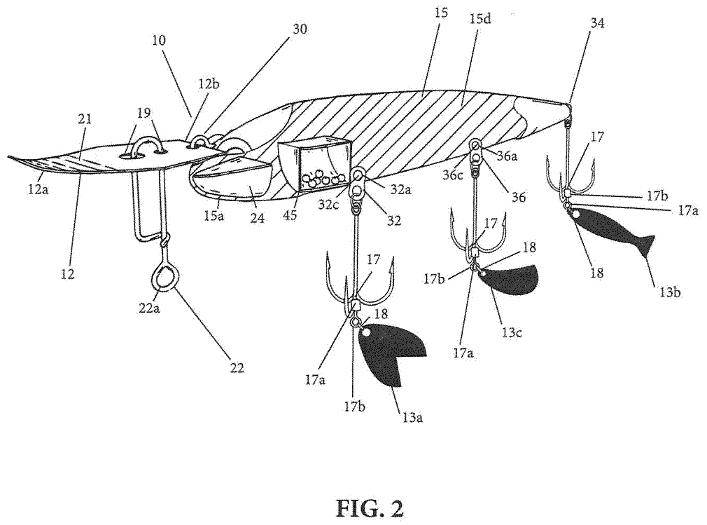

As shown in FIGS. 1 and 2, the lure body may include an additional loop 36 disposed on the lower portion 15b of the lure body 15 for attaching the fishhook 17.

As illustrated, the fishhooks 17 that are releasably attached to the loops 32, 34 and 36 as described, each define, as previously described, the swivel member 17a extending from the bottom of the treble hook, configured for releasably attaching the selected blade 13.

As is known in the art, blades for attracting fish come in multiple shapes, sizes and colors. These various relevant characteristics are all known to better attract fish. It is further known that different shape and/or size blades will give various actions to the fishers lure and, different actions cause different reactions. For example, one particular shaped blade may give the fishers lure a thumping action, while another shape blade will cause the lure to react in a side to side action.

The present invention includes the treble fishhook 17 with swivel member 17a configured to add selected different shape blades 13 for the desired action. Referring to FIG. 2, the fisherman may releasably connect a first design blade, referred to in FIG. 2 as numeral 13a, to the fishhook 17 attached to the second loop 32 disposed on the lower portion 15b of the lure body 15, and a different shaped blade 13b to the fishhook 17 attached to the third loop 34 disposed on the rear portion 15c of the lure body 15. And, a different shaped blade 13c may be used with the fishhook 17 attached to the additional loop 36 disposed on the lower portion 15b of the lure body 15. Each of the different shaped blades for creating a desired action and reaction movement of the fishers lure 10 through the water.

The top blade 12 being attached to the front portion 15a of the lure body 15 in a configuration causing an oscillating motion. The blade 12 is shown as a generally polygonal flat blade member, constructed of a generally flat sheet metal, such as stainless steel, brass or the like. Other materials, such as plastic, are also suitable for blade 12.

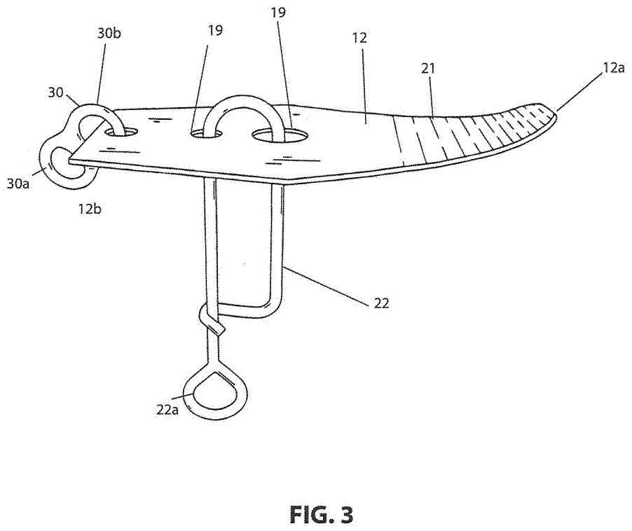

Reviewing the drawings, and in particular FIG. 3, the profile of blade 12 defines a bend 21 near an end 12a of the blade 12. Bending the blade 12 as shown will decrease the effective surface area of the blade 12, decreasing the amount of drag the blade 12 presents as the fishers lure 10 is pulled through the water. It can be appreciated that varying the degree of drag will affect both the tendency of the fishers lure 10 to dive and run to the surface, and the tendency of the blade 12 to oscillate from side to side of the fishers lure 10.

The line attachment holes 19 are formed in the blade 12 generally between the mid-length of the blade and an opposite end 12b of the blade 12, the opposite end 12b being adjacent the front portion 15a of the lure body 15. The line attachment holes 19 for receiving the snap fastener 22, the snap fastener defining a loop 22a for attaching the fishing line. With this configuration, the blade 12 is pulled ahead of the lure body 15 such that water is deflected downward by the blade 12 as the lure 10 moves forward, creating a tendency for the lure 10 to run toward the water surface.

The loops 30, 32, 34 and 36 each define an end 30a, 32a, 34a and 36a that is attached within the lure body 15 and as previously described, opposite loop ends 30b, 32b, 34b and 36b that extend from an exterior of the lure body 15 in order to attach to the fishhook 17. Each loop end 30a, 32a, 34a and 36a are fixedly attached to an interior surface 15d of the lure body 15 and configured to swivel about a pin 30c, 32c, 34c and 36c, respectively. The second loop 32 is positioned between the mid-length of the lure body 15 and the front portion 15a of the lure body. The additional loop 36 is positioned between the mid-length of the lure body 15 and the rear portion 15c of the lure body.

In use, and as the lure 10 is pulled through the water, in addition to the respective loop ends 30a, 32a, 34a and 36a configured to swivel about the pins 30c, 32c, 34c and 36c as discussed, the blade 12 attached at the front portion 15a of the lure body 15 has additional freedom of movement about the loop end 30b. With this configuration, testing has shown the front blade will oscillate as it is pulled through the water. And, the blade(s) 13, when attached at the lower portion 15b of the lure body 15 as described, and the blade 13 when attached at the rear portion 15c of the lure body 15 each have additional freedom of movement about the loop ends 32b, 34b and 36b. With this configuration, testing has shown the lower blade(s) and rear blade will each flicker during use. This oscillating and flickering action by the blades as described, is an effective fishing attractor going thru the water.

As should be understood, with the present inventions, a fisherman can put different size and shape blades on the defined lower and rear portions to give the lure 10 different actions in use.

Referring to FIG. 2, a rattle chamber 45 may be further disposed in the interior 15d of the lure body 15, preferably positioned between the second loop 32 and front portion 15a. The Inventor has found that applying the selected blade 13, such as the known chopper blade, to the treble fishhook 15 on rear portion 15c as described, will cause the lure 10 to react with a thumping action that will shake up the rattle chamber 45 for attracting fish.

FIGS. 1 and 2 show the fishers lure 10 having a first fishhook 17 connected to the second loop 32 of the lower portion 15b of the loop body 15, a second fishhook 17 connected to the third loop 34 disposed on the rear portion 15c of the loop body 15, and a third fishhook 17 connected to the additional loop 36 on the lower portion 15b.

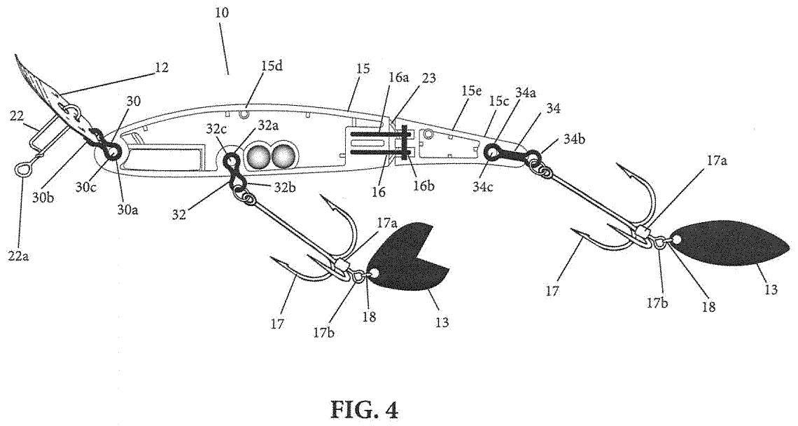

FIG. 4 illustrates an alternated embodiment of the lure body 15, defined by a front body portion 15d and a rear body portion 15e, where the front body portion 15d is hingedly connected to the rear body portion 15e with hinge pin 16 for movement of the rear body portion 15e relative to the front body portion 15d. The hinge pin 16 having a first end 16a connected to the front body portion 15d and a second end 16b connected to the rear body portion 15e. As illustrated, an eye bolt 23 can provide a second connection between the front body portion 15d and the rear body portion 15e.

As illustrated, the lure body in FIG. 4 eliminates the additional loop 36 and therefore has only two (2) fishhooks, i.e., the first fishhook connected to the second loop 32 of the lower portion 15b of the loop body 15, and the second fishhook connected to the third loop 34 disposed on the rear portion 15c of the loop body 15. However, it is anticipated that the lure body 15 having the defined front and rear body portions may include the additional loop 36 disposed on the lower portion 15b of the lure body 15 for attaching the fishhook 17 and blade 13.

The hinged connection between the two (2) body portions as described, promotes a duel action for fish attraction. The oscillating top blade 12 as described with the “jointed” tail section 15c of the rear body portion 15e causing a back and forth action like a real swimming bait fish.

As illustrated and discussed, the blades 13 are attached to the eyelet or loop 17b of the swivel member 17 with the crimped or split ring 18. In the prior art, it is known that blades have a hole at one end for attaching a ball bearing or swivel. One end of the swivel attached to the blade and the other end attached to a wire form for retrieving the lure through the water. When the prior art lure is pulled through the water, it is generally pulled in a straight path with the blade spinning, thumping or fluttering.

With the present fishers lure 10, the top blade 12 is configured to cause the fishers lure 10 to rotate from side to side with every oscillation. This side to side oscillation disrupts the normal straight pull of each blade 13 attached to the respective swivel member 17 causing an erratic action which looks like a school of wounded bait fish which attracts predator fish.

The fishers lure 10 of the present invention takes different weights in the lure body 15 to achieve different depths in the water. The lure body 15 further includes a weighted chamber 24 for receiving selected weights that may be lead or other suitably weighted material, at manufacture. The chamber 24 may be disposed on the interior surface 15d proximate the front portion 15a of the lure body 15. As such, selected weights are added to the weight chamber 24 for shallow to deep depth applications.

Although the above description contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

It would be obvious to those skilled in the art that modifications may be made to the embodiments described above without departing from the scope of the present invention. Thus the scope of the invention should be determined by the appended claims in the formal application and their legal equivalents, rather than by the examples given.

I claim:

1. A fishers lure comprising:
a lure body,
a top blade attached to the lure body in a configuration whereby an oscillating motion is created as movement of the fishers lure through the water displaces the top blade relative to the lure body,
the lure body including multiple treble fishhooks consisting of three hooks with a swivel member extending from the bottom of the treble fishhook,
the lure body further defines a first loop that is disposed on a front portion of the lure body for attaching the top blade, a second loop that is disposed on a lower portion of the lure body for attaching the treble fishhook, and a third loop that is disposed on a rear portion of the lure body for attaching the treble fishhook, wherein each of said treble fishhooks including said swivel member configured for releasably attaching a selected blade for a desired action as the fishers lure is pulled through water.

2. The fishers lure of claim 1, wherein said lure body includes an additional loop disposed on the lower portion of the lure body for attaching the treble fishhook configured for attaching the selected blade.

3. The fishers lure of claim 2, wherein the second loop is positioned between a mid-length of the lure body and the front portion of the lure body, and wherein said additional loop is positioned between the mid-length and the rear portion of the lure body.

4. The fishers lure of claim 1, wherein said top blade is a generally flat blade having a bend near an end of the blade.

5. The fishers lure of claim 1, wherein said lure body further including a weighted chamber.

6. The fishers lure of claim 5, wherein said weighted chamber is disposed on the proximate front portion of the lure body.

7. A fishers lure comprising:
a lure body having a first loop disposed on a front portion of the lure body for attaching a top blade, a second loop disposed on a lower portion of the lure body for attaching a first fishhook, a third loop disposed on a rear portion of the lure body for attaching a second fishhook, and a fourth loop disposed on the lower portion of the lure body for attaching a third fishhook, wherein each of said first, second and third fishhooks including a swivel member configured for releasably attaching a selected blade for a desired action as the fishers lure is pulled through water, and wherein said second loop is positioned between a mid-length of the lure body and the front portion of the lure body, and said fourth loop is positioned between the mid-length and the rear portion of the lure body.

8. The fishers lure of claim 7, wherein said top blade is a generally flat blade having a bend near an end of the blade.

9. The fishers lure of claim 8, further including a weighted chamber disposed on the proximate front portion of the lure body.

10. A fishers lure comprising:
a lure body comprising a front body portion hingedly connected to a rear body portion,
a top blade attached to the lure body in a configuration whereby an oscillating motion is created as movement of the fishers lure through the water displaces the top blade relative to the lure body,
the lure body including multiple treble fishhooks consisting of three hooks with a swivel member extending from the bottom of the treble fishhook,
the lure body further defines a first loop that is disposed on a front portion of the lure body for attaching the top blade, a second loop that is disposed on a lower portion of the lure body for attaching the treble fishhook, and a third loop that is disposed on a rear portion of the lure body for attaching the treble fishhook, wherein each of said treble fishhooks including said swivel member configured for releasably attaching a selected blade for a desired action as the fishers lure is pulled through water.

11. The fishers lure of claim 10, wherein said lure body includes an additional loop disposed on the lower portion of the lure body for attaching the treble fishhook configured for attaching the selected blade.

12. The fishers lure of claim 11, wherein the second loop is positioned between a mid-length of the lure body and the front portion of the lure body, and wherein said additional loop is positioned between the mid-length and the rear portion of the lure body.

13. The fishers lure of claim 10, wherein said top blade is a generally flat blade having a bend near an end of the blade.

14. The fishers lure of claim 10, further including a bolt eyelet configured to connect the front body portion to the rear body portion.

15. The fishers lure of claim 10, wherein said lure body further including a weighted chamber.

16. The fishers lure of claim 15, wherein said weighted chamber is disposed on the proximate front portion of the lure body.
